(19) United States
(12) Patent Application Publication
(10) Pub. No.: US 2013/0233804 A1
(43) Pub. Date: Sep. 12, 2013

(54) APPLICATION OF FLUORESCENT DYES TO TRACE AND QUANTIFY CHEMICAL DOSAGE IN INDUSTRIAL WASTEWATER

(71) Applicants: Yanjiao Xie, Forest Park, IL (US); Xuejun Wang, Oswego, IL (US); Mingli Wei, Naperville, IL (US)

(72) Inventors: Yanjiao Xie, Forest Park, IL (US); Xuejun Wang, Oswego, IL (US); Mingli Wei, Naperville, IL (US)

(21) Appl. No.: 13/416,272

(22) Filed: Mar. 9, 2012

(51) Int. Cl. C02F 1/00; C02F 1/52

(52) U.S. Cl. 210/709; 210/745

(57) ABSTRACT

Disclosed are methods and chemicals that can be used as fluorescent tracers in the treatment of raw water and/or industrial wastewater. The fluorescent tracers are certain chemicals discovered to have beneficial properties for such uses, particularly having little variance in fluorescence emission for conditions that are known to interfere with fluorescence emission. The fluorescent tracers comprise rhodamine dyes.

### FIELD OF THE INVENTION

The invention is directed toward treatment of industrial wastewater. In particular the invention is directed toward fluorescently tracing treatment chemicals that are added to industrial wastewater. The invention allows for the efficient treatment of industrial wastewater using a treatment technology such as TRASAR® technology or 3D TRASAR® technology, each available from Nalco, an Ecolab Company, 1601 West Diehl Road, Naperville, Ill. 60563.

### BACKGROUND

Wastewater, particularly industrial wastewater, can be difficult to cost-effectively treat because of its physical and chemical properties. Wastewater can be comprised of various chemical and biological species, including suspended solids. As such, there has been a long-felt but unmet need to more efficiently treat wastewater, particularly industrial wastewater.

The use of dyes as tracing chemicals was patented by John Hoots of Nalco Company in 1988 (U.S. Pat. No. 4,783,314), and subsequent patent applications were filed for specific industrial applications, such as disulfonated anthracenes as inert tracer for boiler water (U.S. Pat. No. 7,220,382 to Godfrey et al.).

The synthesis of rhodamine dyes was patented by Mayer et al., U.S. Pat. No. 4,647,675, issued Mar. 3, 1987. As a commercially available dye, Rhodamine WT has been used in hydrological studies of surface water, ground water, and wastewater (Mon, J. and Flury, M., 2005, Dyes As Hydrological Tracers, Water Encyclopedia, 95-102; YSI Environmental 1006 E46-01); and herbicide tracing in surface water and ground water (YSI Environmental 1006 E46-01).

Industrial wastewater treatment processes have avoided using fluorescent tracers in industrial wastewater due to its high fluorescence background and high interfering light-scattering signal from suspended solids. It is very difficult to find an inert dye that overcomes the interference from high fluorescent background and high suspended solids present in industrial wastewater. The interference from charged coagulants and flocculants and other contaminants in wastewater add difficulty in finding a suitable inert fluorescent dye.

Accordingly, there is a need for a fluorescent dye that can be used in tracing treatment chemicals in industrial wastewater. Desirably, the dye will overcome the obstacles presented by industrial wastewater that make it difficult to fluorescently trace treatment chemicals.

### SUMMARY OF THE INVENTION

In an embodiment, the invention is directed toward a method for measuring concentration and optionally controlling dosage of at least one treatment chemical into industrial wastewater, the method comprising the following steps: providing the industrial wastewater; dosing the at least one treatment chemical into the industrial wastewater to create a treated industrial wastewater, wherein the at least one treatment chemical is traced with a dye; measuring the fluorescence of the treated industrial wastewater; and optionally adjusting the dosing based on the measuring; wherein the dye comprises a structure:

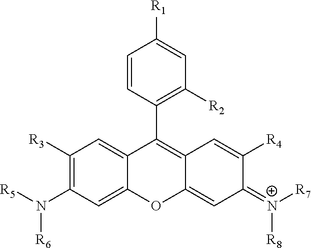

wherein R1 and R2 are independently selected from the group consisting of hydrogen, sulfonic acid, a sulfonic acid salt, carboxylic acid, a carboxylic acid salt, an ester, and an amide derivative, and wherein R3, R4, R5, R6, R7, and R8 are independently selected from the group consisting of hydrogen, a halogen, and a C1-C8 alkyl.

In another embodiment, the invention is directed toward a method for measuring concentration and optionally controlling dosage of at least one treatment chemical into industrial wastewater, the method comprising the following steps: providing the industrial wastewater; dosing the at least one treatment chemical into the industrial wastewater to create a treated industrial wastewater, wherein the at least one treatment chemical is traced with a dye; measuring the fluorescence of the treated industrial wastewater; and optionally adjusting the dosing based on the measuring; wherein the dye is selected from the group consisting of Rhodamine WT, Sulforhodamine B, Rhodamine B, and combinations thereof.

These and other features and advantages of the present invention will be apparent from the following detailed description, in conjunction with the appended claims.

### BRIEF DESCRIPTION OF THE SEVERAL VIEWS OF THE DRAWINGS

The benefits and advantages of the present invention will become more readily apparent to those of ordinary skill in the relevant art after reviewing the following detailed description and accompanying drawings, wherein:

FIG. 1 is a bar graph showing variation in fluorescence emission of the invention when dosed into several industrial wastewater samples versus the control sample;

FIG. 2 is a bar graph showing variation in fluorescence emission of the invention when dosed into several flocculant samples versus the control sample;

FIG. 3 is a bar graph showing variation in fluorescence emission of the invention when dosed into several coagulant samples versus the control sample;

FIG. 4 is a bar graph showing variation in fluorescence emission of the invention when dosed into samples with varying pH versus the control sample; and

FIG. 5 is a bar graph showing variation in fluorescence emission of the invention when dosed into samples having other potential interference (surfactant, oil, hardness, etc.) versus the control sample.

### DETAILED DESCRIPTION OF THE INVENTION/PREFERRED EMBODIMENT

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description of the Invention,” relates to a requirement of the United States Patent Office, and does not imply, nor should be inferred to limit the subject matter disclosed herein.

The invention is to dose treatment chemicals that are traced with at least one rhodamine dye into industrial wastewaters and raw waters. The rhodamine dye may comprise a chemical having the chemical structure illustrated in the Summary of the Invention. The rhodamine dye can be used as an inert tracer chemical in industrial wastewaters. The invention overcomes issues related to interference caused by conditions that are traditionally found in raw water and industrial wastewater, such as the presence of certain contaminants and treatment chemicals, and particularly certain contaminants and treatment chemicals present at relatively high concentrations.

The invention can provide the ability to monitor and control the dosage of coagulants and/or flocculants online and in real time using TRASAR or 3D TRASAR technology, or similar technology, which is a long-felt but unmet need in the industry. The ability to automate such treatment can improve the efficiency and reduce total cost of operation of raw water and/or industrial wastewater treatment systems, meeting the industry's need. The invention at hand can be used to improve effluent quality for regulatory compliance and system stability. The invention can also allow for more accurate chemical dosing for performance optimization and alarms on system issues, such as pump failures and empty chemical tanks, thereby reducing system upsets. The invention can be used in various wastewater automation processes, such as dissolved air flotation (“DAF”) automation and clarification dosage optimizing.

A wastewater treatment plant can take on various embodiments. The plant will typically comprise various treatment stages in sequence: primary treatment; secondary treatment; tertiary treatment; sludge stabilization; sludge thickening; and sludge dewatering. An industrial wastewater treatment plant can have some or all of the stages of the typical wastewater treatment plant.

In primary treatment, a screen is firstly used to remove large debris and particles, and a dissolved air flotation (“DAF”) device or clarifier is then used to separate suspended solids. Treatment chemicals, such as coagulant, flocculant, and possibly heavy metal removing reagents, are usually added to treat primary wastewater.

In secondary treatment, aerobic or anaerobic biological systems are used to remove dissolved solids and contaminants. Treatment chemicals, such as coagulant, flocculant, or membrane flux enhancers, are added in the effluent of biological systems to separate the solids generated by the biological systems. After chemical addition, a clarifier, a DAF, a membrane, a filter system, or some combination of one or more of these is used to separate the solids generated in the secondary treatment.

Following secondary treatment, tertiary treatment includes chemical oxidation of persistent contaminants or adsorption of pollutants using sorbents like activated carbon. Treatment chemicals used in tertiary treatment include oxidants, such as hydrogen peroxide. The final effluent after tertiary treatment is either discharged to surface water or recycled back to plant processes.

The sludge (solids) separated in primary treatment and secondary treatment is combined for further treatments to remove residual water from solids. Sludge stabilization using anaerobic digesters and sludge thickening are the pretreatment steps before sludge dewatering. In sludge dewatering, flocculant (coagulant as well in some cases) can be added before the sludge is sent to to a sludge dewatering device, such as a belt press or centrifuge.

In an embodiment, the dye is selected from the group consisting of Rhodamine WT, Sulforhodamine B, Rhodamine B, and combinations thereof. In a preferred embodiment, the dye is Rhodamine WT.

In an embodiment, the method is performed automatically via feedback control. A preferred embodiment incorporates TRASAR or 3D TRASAR technology, available from Nalco, an Ecolab Company, 1601 West Diehl Road, Naperville, Ill. 60563, www.nalco.com.

In an embodiment, the dye is essentially inert.

In an embodiment, the treatment chemical may comprise a coagulant, a flocculant, both a coagulant and a flocculant, or some combination of multiple coagulants and/or flocculants.

The method may additionally comprise the step of measuring turbidity of the industrial wastewater and/or raw water. If so, then the method may additionally comprise the step of correcting the measuring the fluorescence for the measured turbidity. The method may additionally comprise the step of adjusting the dosing based on the corrected measured fluorescence.

### EXAMPLES

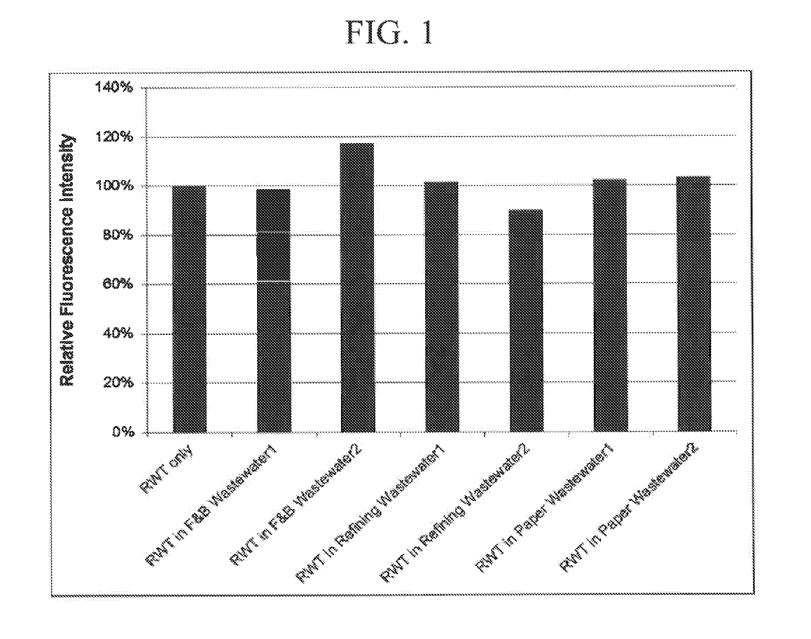

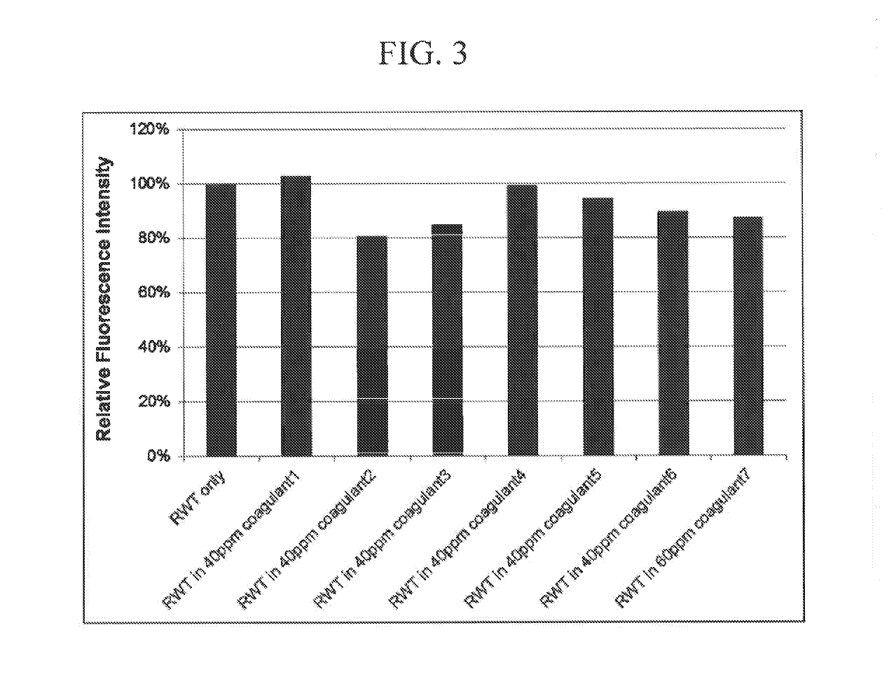

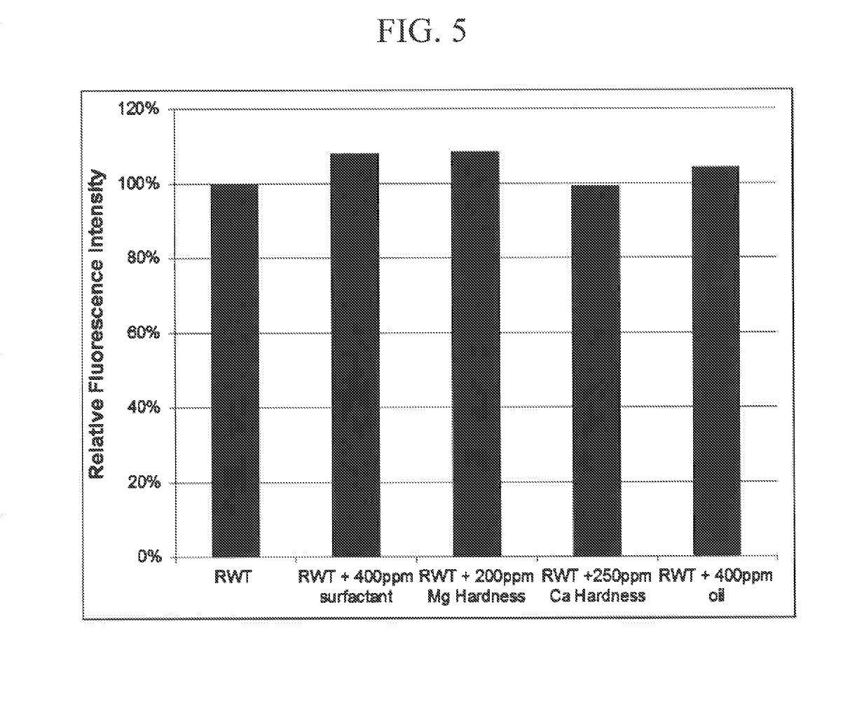

The following experiments were performed obtaining the results illustrated in FIGS. 1-5.

### Experimental Procedure:

The appropriate amount of Rhodamine WT (“RWT”) stock solution was added to deionized water to make a 100 ppb RWT control solution. The results of the control sample can be found throughout the figures.

The following samples were prepared and tested for fluorescence emission at a controlled concentration of RWT. Once the samples were prepared, the fluorescence emission spectra of each sample was collected at the appropriate excitation wavelength, 510 nm. The final step of the procedure was to calculate the accumulative fluorescence intensity over the emission range.

### Samples:

For wastewater experiments, two types of wastewater were used. Firstly, actual wastewater samples were obtained from paper, food and beverage (“F&B”), and refining industries. Results for these experiments can be found in FIG. 1.

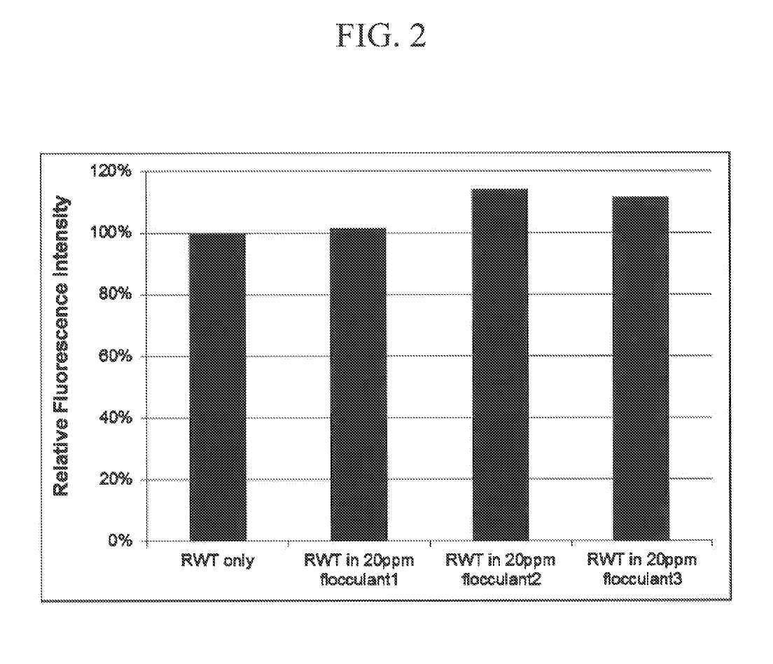

Secondly, synthetic wastewater samples were made by diluting a certain amount of contaminant or chemical into deionized water, such as coagulant, flocculant, surfactant, oil, CaCl₂, MgCl₂, etc. The same aliquot of RWT stock solution was then added into each of the wastewater samples to make sample solutions with 100 ppb RWT. Results for these experiments can be found in FIGS. 2, 3, and 5.

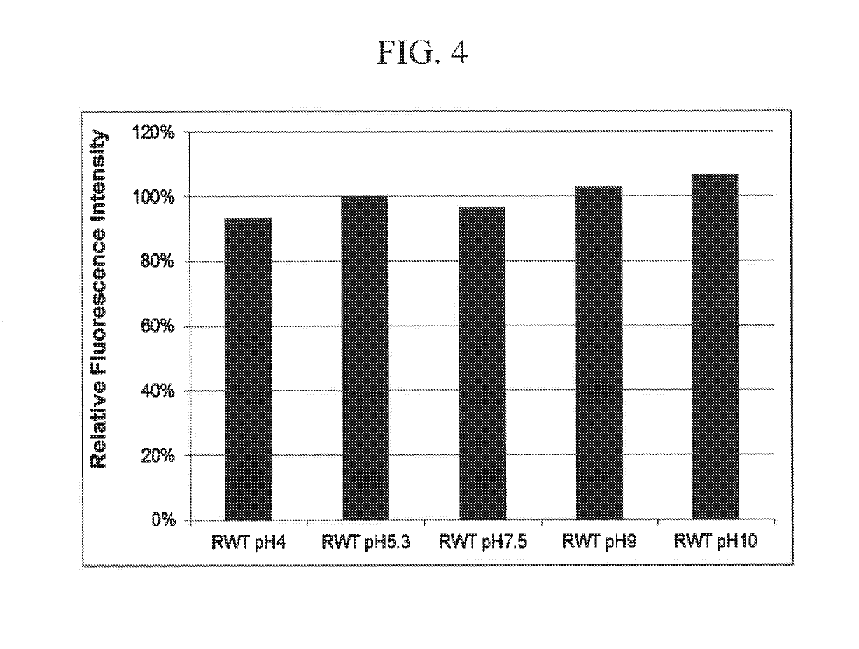

For the pH-specific experiments, the pH of the solutions was adjusted by adding NaOH or HCl as necessary. The results for these experiments can be found in FIG. 4.

### Results:

The graphs illustrated in FIGS. 1-5 show the experimental results. The “RWT only” is the control sample. The graphs illustrate that less than 20% variation in the fluorescence intensity was observed between the control sample and all wastewater samples, which is an acceptable range in the industry.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the illustrated specific embodiments or examples is intended or should be inferred. The disclosure is intended to cover by the appended claims all such modifications as fall within the scope of the claims.

We claim:

1. A method for measuring concentration and optionally controlling dosage of at least one treatment chemical into industrial wastewater, the method comprising the following steps:
providing the industrial wastewater;
dosing the at least one treatment chemical into the industrial wastewater to create a treated industrial wastewater, wherein the at least one treatment chemical is traced with a dye;
measuring the fluorescence of the treated industrial wastewater; and
optionally adjusting the dosing based on the measuring;
wherein the dye comprises a structure 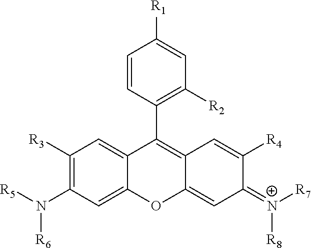
wherein R₁ and R₂ are independently selected from the group consisting of hydrogen, sulfonic acid, a sulfonic acid salt, carboxylic acid, a carboxylic acid salt, an ester, and an amide derivative, and wherein R₃, R₄, R₅, R₆, R₇, and R₈ are independently selected from the group consisting of hydrogen, a halogen, and a C₁-C₈ alkyl.

2. A method for measuring concentration and optionally controlling dosage of at least one treatment chemical into industrial wastewater, the method comprising the following steps:
providing the industrial wastewater;
dosing the at least one treatment chemical into the industrial wastewater to create a treated industrial wastewater, wherein the at least one treatment chemical is traced with a dye;
measuring the fluorescence of the treated industrial wastewater; and
optionally adjusting the dosing based on the measuring;
wherein the dye is selected from the group consisting of Rhodamine WT, Sulforhodamine B, Rhodamine B, and combinations thereof.

3. The method of claim 1, wherein the method is performed automatically via feedback control.

4. The method of claim 1, wherein the dye is essentially inert.

5. The method of claim 1, wherein the at least one treatment chemical comprises a coagulant.

6. The method of claim 1, wherein the at least one treatment chemical comprises a flocculant.

7. The method of claim 1, wherein the at least one treatment chemical comprises a coagulant and a flocculant.

8. The method of claim 3, wherein the method additionally comprises the steps of measuring turbidity of the industrial wastewater, and correcting the measuring the fluorescence for measured turbidity, and optionally adjusting the dosing based on the corrected measured fluorescence.
